(19) United States
(12) Patent Application Publication
(10) Pub. No.: US 2026/0096690 A1
(43) Pub. Date: Apr. 9, 2026

(54) AUTOMATED FOOD FRYING SYSTEM

(71) Applicant: Miso Robotics, Inc., Pasadena, CA (US)

(72) Inventors: Bachir Kharraja, Irvine, CA (US); Zachary Zweig Vinegar, Pasadena, CA (US); Richard Parks, Huntington Beach, CA (US); Nicholas Ardavin, Los Angeles, CA (US); Wai Winnie Lam, Temple City, CA (US); Hendry Joe, Irvine, CA (US); Philip Stahlhuth, Pasadena, CA (US); Darren Cooper, Pasadena, CA (US); Jonathan Cheng, Los Angeles, CA (US); Ibrahim Helal, Pasadena, CA (US); Anthony Margulis, Granada Hills, CA (US); Arild Jensen, Santa Clarita, CA (US); Saeed Taheri, Portland, OR (US); Pruthvikumar Sureshkumar Sanghavi, Pasadena, CA (US); Yusuke Kojitani, Pasadena, CA (US); Abhishek Raj, Pasadena, CA (US)

(21) Appl. No.: 19/344,049

(22) Filed: Sep. 29, 2025

Related U.S. Application Data
(60) Provisional application No. 63/703,953, filed on Oct. 5, 2024.

(51) Int. Cl. A47J 37/12; B25J 19/02; G06V 10/764; G06V 20/68

(52) U.S. Cl. CPC A47J 37/1228; A47J 37/1219; A47J 37/1266; A47J 37/129; A47J 37/1295; B25J 19/021; G06V 10/764; G06V 20/68

(57) ABSTRACT

An automated food frying system includes an enclosure defining a robotic workspace, a robotic arm and a plurality of functional stations for dispensing raw food to a bin, transferring the raw food from the bin to a fry basket, frying the raw food, and transferring the cooked food to a receiving pan. Optionally, an auto-drawer station is arranged and operable within the enclosure to transfer an entire fry basket of order-specific food between an operator and the robotic arm without the operator or the robotic arm penetrating the enclosure. Related methods are described.

### CROSS-REFERENCE TO RELATED APPLICATIONS

This claims priority to application number 63/703,953, filed Oct. 5, 2024, and entitled “AUTOMATED FOOD FRYING SYSTEM” incorporated herein by reference in its entirety for all purposes.

### BACKGROUND OF THE INVENTION

### 1. Field of the Invention

This invention relates to food frying systems, and more particularly, to automated food frying systems adapted to provide freshly fried food items without human interaction.

### 2. Description of Related Art

In the restaurant environment, fried food items are prepared by restaurant employees using conventional fryers. The restaurant employee takes an order, manually adds the raw food items to the fry basket, lowers the fry basket into the fryer, cooks the food items, removes the fry basket from the fryer, and dumps the cooked food items into a pan. The process relies heavily on employee labor, exposes the employee to dangerous hot oil, is prone to inconsistencies, and is not scalable for multiple orders.

There is therefore a need for improved fryer systems, and particularly, one that is fully automated.

### SUMMARY OF THE INVENTION

In embodiments of the invention, an enclosed automated food frying system for frying food includes a robotic arm and a plurality of functional stations operable to dispense, transfer, and fry the food.

In embodiments of the invention, an auto-drawer station is arranged and operable with the enclosure to transfer an entire fry basket of order specific food between an operator and the robotic arm without the operator or the robotic arm penetrating the enclosure.

In embodiments of the invention, an elevator station is operable for transferring the raw food from a basin to the fry basket.

In embodiments of the invention, the automated food frying system includes a computer system and electronics programmed and operable to control the robotic arm and the functional stations.

In embodiments of the invention, the computer system and electronics are programmed and operable to automatically select, based on a customer order and data arising from sensors or cameras, between whether to (a) dispense the raw food into the basin, and to transfer the raw food from the basin to the fry basket; and (b) pick up a fry basket of raw food from the auto-drawer station.

In embodiments of the invention, the automated food frying system includes a touchscreen display in communication with the computer system and is operable to, amongst other things, receive a customer order, display current orders in progress, and display an order queue.

In embodiments of the invention, the computer is programmed and operable store and update status of the food, wherein the status comprises at least one status from the groups comprising: on-line/ready, dispensing, frying, order ready/pickup, service, off-line.

In embodiments of the invention, a method for automatically frying food comprises the following steps: dispensing raw food into a basin; transferring the raw food from the basin to a fry basket; frying the raw food; and robotically moving the cooked food into a receiving area; and wherein each of the steps is controlled by a computer system.

In embodiments, the method further comprises transferring an entire fry basket of order-specific food between an operator and the robotic arm without the operator or the robotic arm penetrating an enclosure surrounding the robotic workspace.

In embodiments of the invention, transferring the raw food comprises elevating the raw food to a target elevation above the fry basket, and dumping or otherwise releasing the raw food into the fry basket.

The description, objects and advantages of the present invention will become apparent from the detailed description to follow, together with the accompanying drawings.

### BRIEF DESCRIPTION OF THE DRAWINGS

FIG. 1 illustrates a left-side top isometric view of an automated food frying system in accordance with an embodiment of the invention;

FIG. 2 is a front view of the automated food frying system shown in FIG. 1;

FIGS. 3-4 show right and left side views, respectively, of the automated food frying system shown in FIG. 1;

FIG. 5 is a top view of the automated food frying system shown in FIG. 1;

FIG. 6 is a flow chart of a method for frying food in accordance with an embodiment of the invention;

FIGS. 7-9 show sequentially the elevator moving from a lower first position for receiving the raw food to an elevated second position for dumping the raw food into the fry basket in accordance with embodiments of the invention;

FIG. 10 shows a schematic illustration of an elevator assembly in accordance with an embodiment of the invention;

FIGS. 11-12 show an automated basket station in an extended and retracted position, respectively, in accordance with embodiments of the invention;

FIGS. 13-14 show isolated side perspective views of the automated basket station in a retracted and extended position, respectively, in accordance with embodiments of the invention;

FIG. 15 is flow chart of an automated basket process, in accordance with embodiments of the invention;

FIGS. 16-17 show sequentially robotically moving the fry basket from outside the fryer reservoir to inside the fryer reservoir in accordance with embodiments of the invention;

FIG. 18 is a rear perspective view of a fryer station in accordance with an embodiment of the invention;

FIGS. 19A-19D are top, front, right side, and left-side bottom perspective views, respectively, of the fryer station in accordance with an embodiment of the invention;

FIG. 20 is a partial sectional view of a fryer station, in accordance with embodiments of the invention;

FIG. 21 is a front perspective view of a fryer station in accordance with an embodiment of the invention;

FIGS. 22-23 show sequentially robotically removing the fry basket form the fryer and rotating the fry basket for dumping the cooked food onto a chute in accordance with embodiments of the invention; and

FIG. 24 is a block diagram of an automated food frying system in accordance with an embodiment of the invention.

### DETAILED DESCRIPTION OF THE INVENTION

Before the present invention is described in detail, it is to be understood that this invention is not limited to particular variations set forth herein as various changes or modifications may be made to the invention described and equivalents may be substituted without departing from the spirit and scope of the invention. As will be apparent to those of skill in the art upon reading this disclosure, each of the individual embodiments described and illustrated herein has discrete components and features which may be readily separated from or combined with the features of any of the other several embodiments without departing from the scope or spirit of the present invention. In addition, many modifications may be made to adapt a particular situation, material, composition of matter, process, process act(s) or step(s) to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present invention (in which case what is present herein shall prevail).

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Last, it is to be appreciated that unless defined otherwise, all technical and scientific terms used herein have the same meaning as commonly understood by one of ordinary skill in the art to which this invention belongs.

### Apparatus Overview

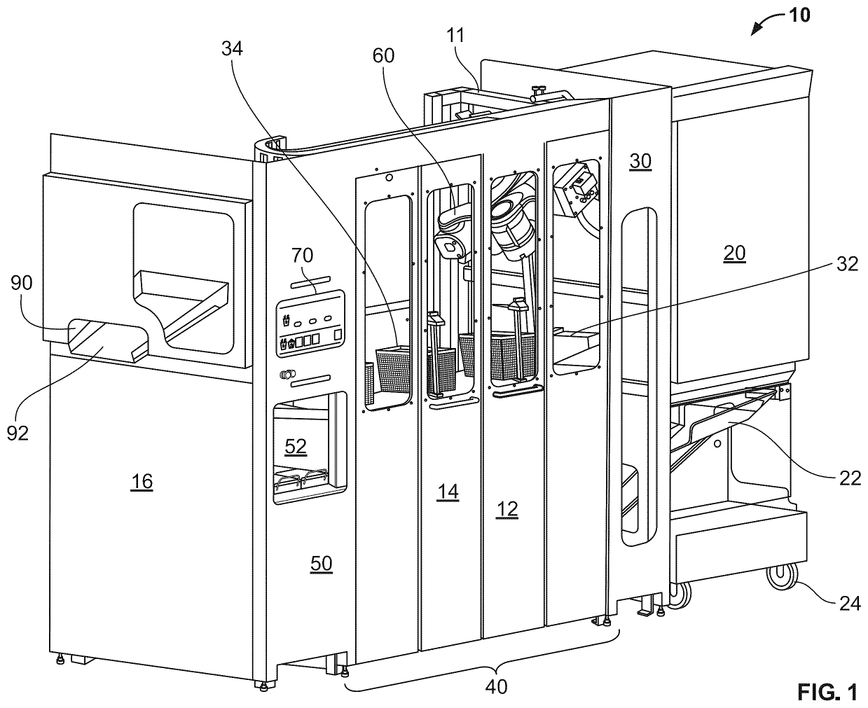

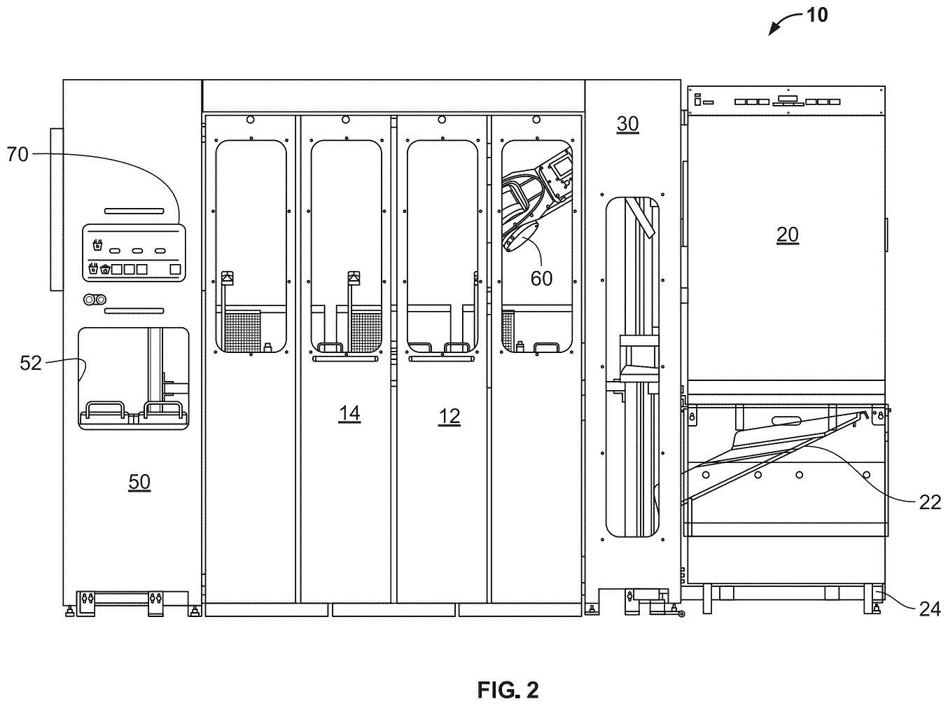

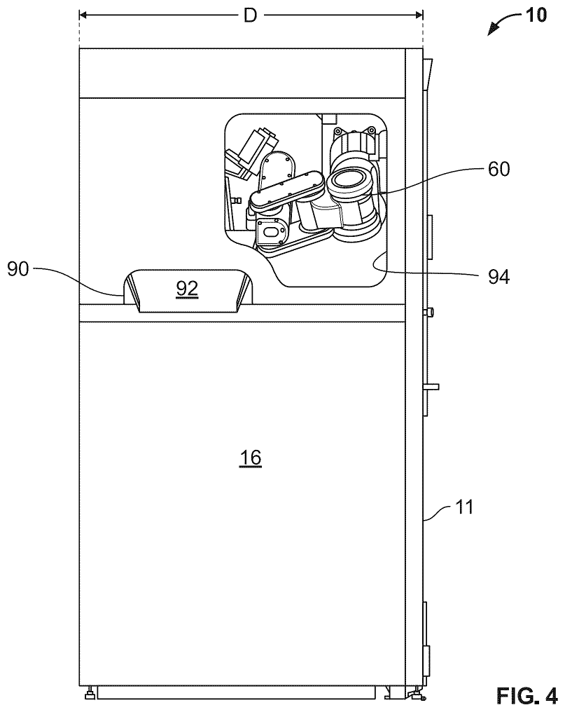

FIGS. 1-5 show various views of an automated food frying system 10 for frying raw food in accordance with an embodiment of the invention. Non-limiting examples of types of raw foods for frying include tortilla chips, fries, popcorn chicken, chicken nuggets or wings, fish sticks, and vegetables.

The system 10 is shown having several functional stations or modules including a refrigerated food dispenser/hopper 20, a raw food transfer station 30 (including elevator basin 32), fryer station 40 (including fryers 42, 44, 46), automated basket station 50 (including raw food ingress window 52), robotic arm 60, touchscreen user interface 70, and cooked food egress window 90 (including chute 92), each of which is discussed herein.

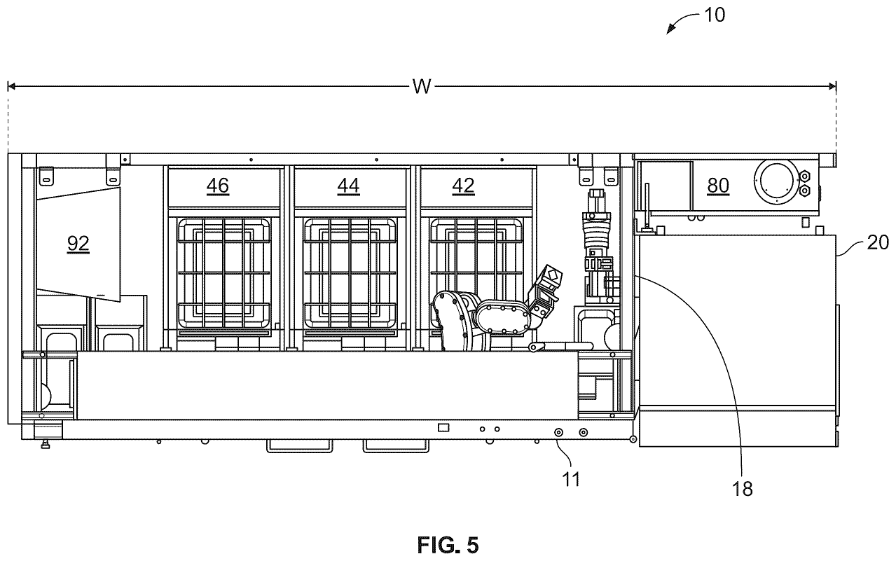

Functional stations 30, 40, and 50 are shown arranged within an enclosure, thereby defining a robotic workspace that separates the robotic arm from a human or operator. The enclosed or walled robotic workspace is shown having a frame 11, front doors 12, 14, left side wall 16, and right side wall 18. With reference to FIG. 5, the dispenser 20 is located in a square space defined by the right side wall 18 of the enclosure and the electronic box assembly 80. Optionally, a sensor (e.g., a magnetic proximity sensor) is arranged on the frame or electronic box assembly to confirm proper location of the dispenser 20 relative to the frame and enclosed robotic workspace. Optionally, the dispenser 20 includes castors 24 for adjusting its location relative to the robotic enclosure.

Additionally, electronic and computer components, discussed herein, can be enclosed within an electronics housing or enclosure 80 and mounted to the frame 11 for controlling the various stations and collecting and storing data.

The entire footprint of the automated fry system 10 shown in FIGS. 1-5 including the dispenser 20, electronics box 80, and the enclosed robotic workspace housing including the elevator station 30, fryer station 40, automated basket station 50, and egress station and chute 90/92 is relatively small. Exemplary ranges for the width (W), height (H), and depth (D) are, respectively, 100-150 in., 50-100 in., and 30-50 in. An exemplary small size (e.g., 3 fryer 2 auto-drawer/basket) is about 117″ (W), 76″ (H), 41.5″ (D), and large size (e.g., 4 fryer 3 auto-drawer/basket) is about 142″ (W), 76″ (H) same as small, and 41.5″ (D) same as small.

What is more, the rear area above the fryer station is open which allows the system 10 to be conveniently installed and integrated with existing restaurant kitchen hoods normally built in above pre-existing fryers. In embodiments, installation of the automated fry system does not require revision of the existing hood assembly.

Additionally, although the system 10 is shown with robotic arm 60 mounted from above the fry station 40, in other embodiments, the robotic arm can be arranged as a stand-alone unit adjacent the fryers.

### Method Overview

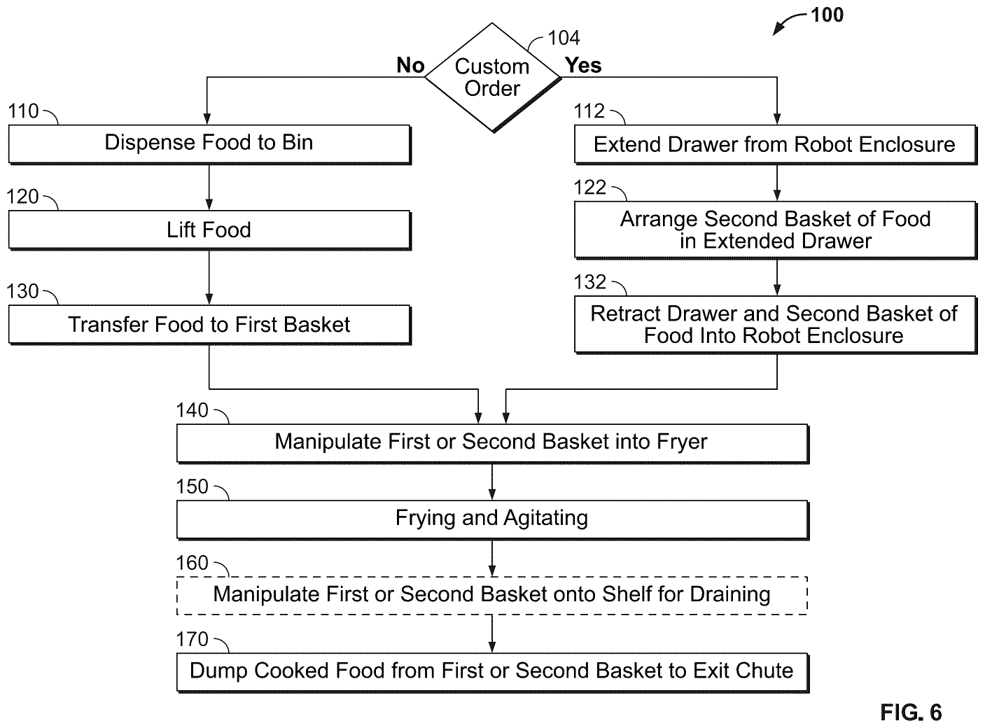

FIG. 6 shows a flow chart of a method 100 of frying raw food in accordance with an embodiment of the invention.

Step 104 queries for whether the order is a custom order. A user instruction may be received via, e.g., the touchscreen display 70 for the default food order or a custom food order. If the order is directed to the default food order, the process automatically proceeds to step 110. If, on the other hand, a custom food order is desired of a type or quantity of raw food not available from the dispenser station 20, the process automatically proceeds to step 112.

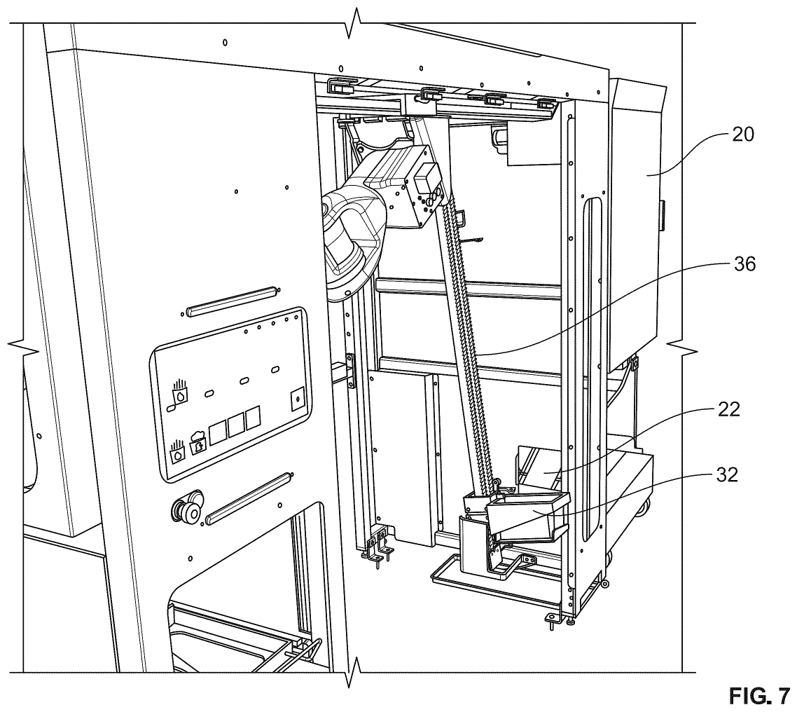

Step 110 states to dispense food to the bin. In embodiments, this step includes lowering the food bin 32 via the elevator rail 36 to the lower first position. This step may be performed with reference to FIG. 7 in which the cold or raw food is gravity fed along ramp 22 and into elevator basin 32. As stated above, an example of a suitable refrigerated food hopper/dispenser is the RAM 280, manufactured by Taylor UK (Ipswich, England). It can be controlled by the electronics module 80 to dispense a predetermined amount of raw food when the basin is in the first ‘receiving’ position. In embodiments, a position sensor is arranged at the bottom of the rail to detect for the basin reaching the lower first position and the dispenser 20 is instructed to dispense raw food when an order is called, and the basin is in the first position. In embodiments, the rail 36 includes a hard stop at the first position, through which the basin cannot pass.

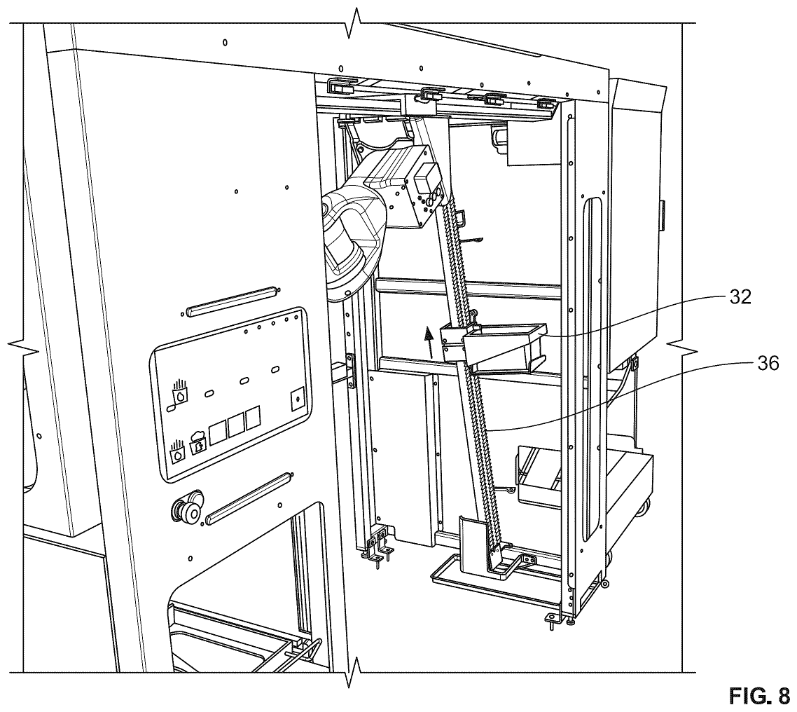

Step 120 states to lift food. With reference to FIG. 8, the basin 32 is shown being elevated along rail 36. In embodiments, rail is configured as part of a linear rail/guide system including an electric motor operable to raise and lower a carriage, upon which the basin is mounted. An exemplary linear rail and motor is the NEMA 23 ClearPath-SCSK Model, by Teknic, Inc. (Victor, New York)

### Elevator Basin Food Transfer

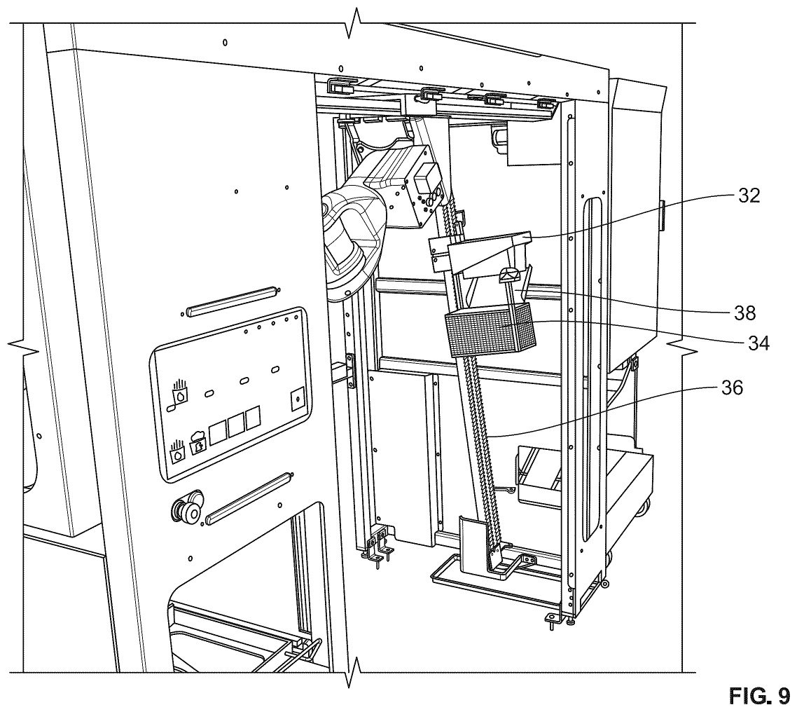

Step 130 states to transfer food to first basket. With reference to FIG. 9, the basin 32 is lifted along linear actuator 36 to its elevated food transfer (or dump) position. Door 38 is opened to allow the food to fall into the fry basket 34.

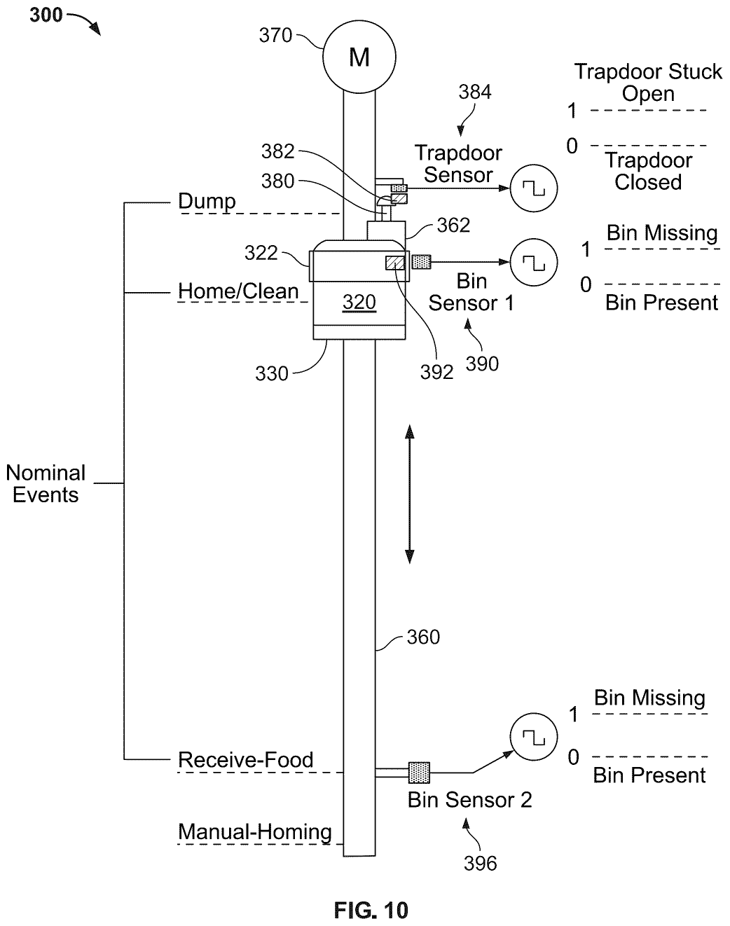

In embodiments, and with reference FIG. 10, a schematic illustration of an elevator assembly 300 is shown in accordance with embodiments of the invention. The basin 320 is shown removably fitted in frame 322 which is mounted to carriage 362. Carriage is movable along rail 360 by motor 370. Door 330 is arranged in a normally closed position. For embodiments, the door is spring loaded closed with sufficient force to remain closed when the basin is full of raw food.

A spring-loaded shaft 380 is mechanically operably linked to the door 330 such that as basin is moved upwards to the dump position, the shaft 380 is depressed, and the trap door is opened. Sensor reader 384 detects first magnet 382 corresponding to opening the trap door 330.

The system pauses to allow sufficient time for the food to be dumped from the basin. Then, as the basin is lowered, spring loaded shaft 380 is released and returns to its initial neutral position, and consequently, returning the door 330 to its initial closed configuration.

Next, the basin is returned to home position to await the next command or for cleaning. The presence of the basin at the home location can be detected by sensor reader 390 and second magnet 392.

When a command to dispense food is received, the basin 320 is lowered to the receive-food position. The presence of the basin at the receive-food location can be detected by sensor reader 396 and magnet 392.

### Auto-Drawer/Basket Food Transfer

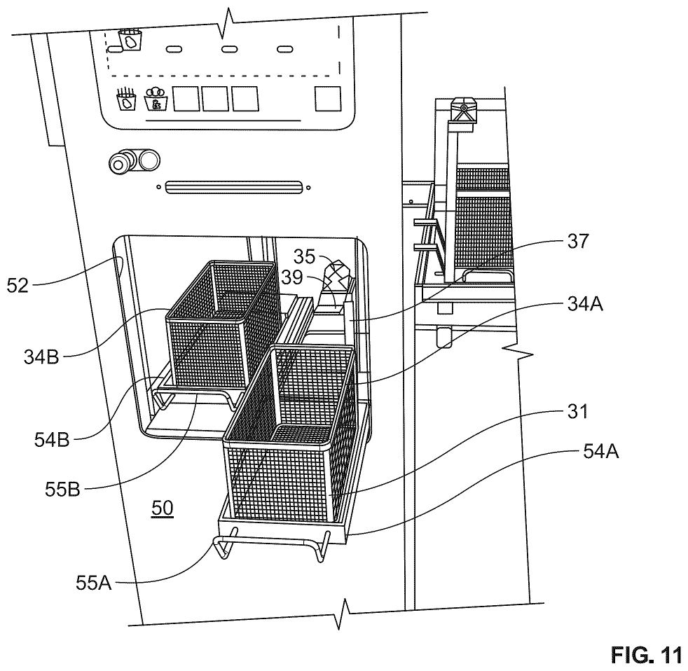

With reference again to FIG. 6, if a custom food order is desired of a type or quantity of raw food not available from the dispenser station 20, the process automatically proceeds to step 112. Step 112 states to extend first drawer from robot enclosure. This step may be performed as shown in FIG. 11 in which first drawer 54A is shown in an extended position from ingress opening 52. The wall forming the auto-drawer station 50 separates the human workspace form the robot workspace.

A basket 34A is shown in the extended drawer. The basket could be filled with a second type of raw food, different than the first type of raw food held in the dispenser 20. The basket could be filled before or after being arranged in the drawer (step 122).

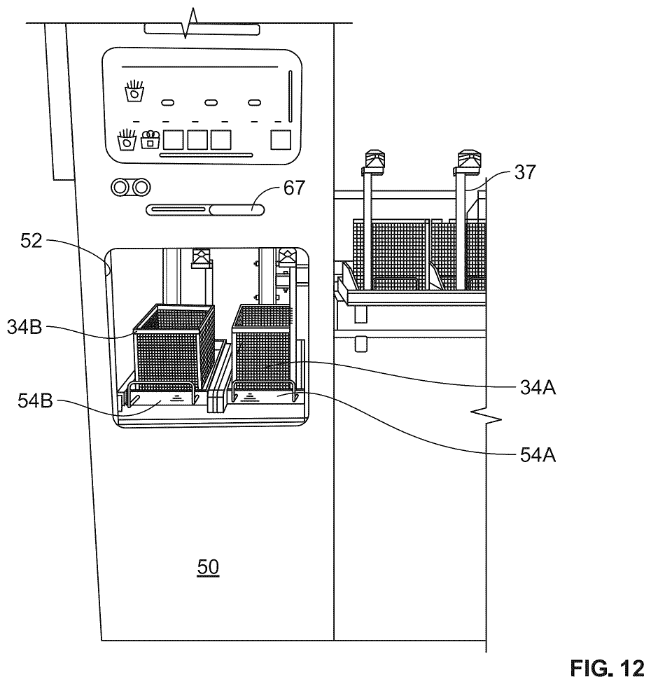

Step 132 states to retract the drawer and basket of food into the robot enclosure. This step may be performed as shown in FIG. 12 in which the drawer 54A and basket 34A are positioned within the robotic auto-drawer station 50 of the robotic enclosure.

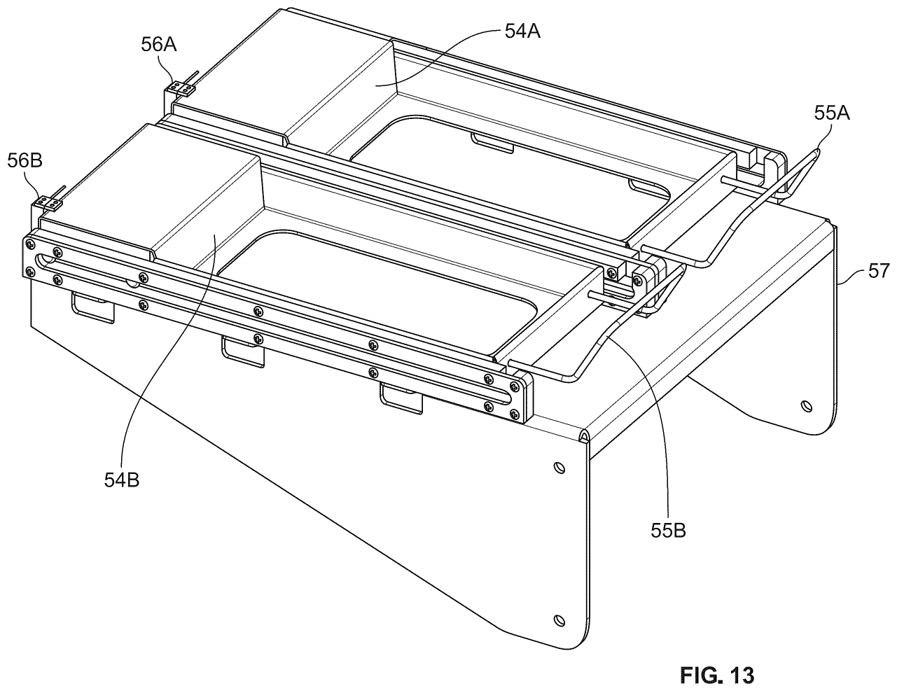

In embodiments, the drawers 54A, 54B are manually operated to extend and retract. Handles 55A, 55B are shown extending from each drawer 54A, 54B, respectively. For embodiments, and with reference to FIG. 13, a support 57 is shown to which rail guides for the drawers are mounted. Several proximity sensors are incorporated into the support to detect the position of each of the drawers. In embodiments, proximity sensors 56A, 56B are arranged at the rear end of the support 57 to detect when each drawer is closed.

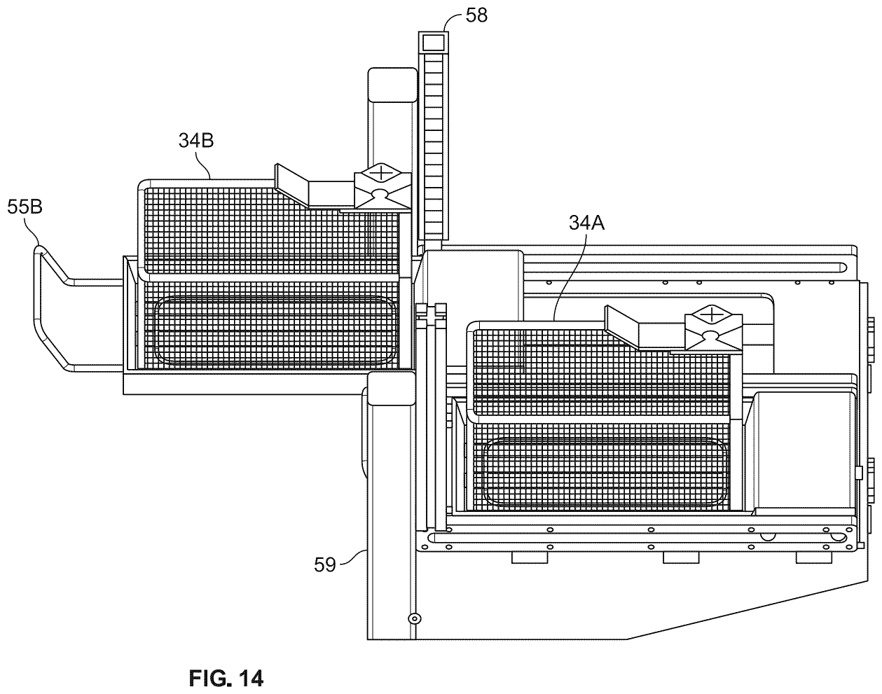

FIG. 14 shows an upper right side perspective view of the auto-drawer station 50 in an extended configuration as mounted to wall 59. Also shown is safety light curtain 58 operable to detect any disruption through the ingress opening 52. In embodiments, when the window is penetrated or disrupted by an object, the robotic arm pauses until a user overrides the action. In this manner, if a basket is being moved between the extended position and retracted position, the robotic arm shall pause until basket is returned to the retracted position, and optionally, the operator confirms the robotic arm is to proceed. This ensures the user's safety in case they are interacting with the basket without pulling out the drawer or if, for whatever reason, they are reaching into the robot's operation zone.

The inventors have found the auto-drawer station 50 has a number of advantages. For example, there may be orders for raw foods that are different than the limited pre-stored raw food in the dispenser 20 described above. The auto-drawer station allows the user to add or change or customize an order by adding any type of raw food desired ad hoc, i.e., there is no need to have change out the hopper in the dispenser. What is more, for embodiments, the system automatically can pick up and fry the custom raw food—it is not done manually. For embodiments, the automatic fry system 10 described herein provides for high throughput repeat orders via the dispenser, and optionally, automated cooking of custom or one-up orders without the user being required to perform any frying.

Additionally, whole baskets of food may be provided to the robot for cooking. Additionally, when the operator desires to remove or replace a basket, the basket can be removed without the operator or the robot offending or disrupting the walled workspace.

The operator has at least the following options when the drawer has been pulled out or otherwise in the extended position: place uncooked food into an existing empty basket, if any; put empty basket into the slot for future use; put basket with uncooked food into slot for cooking; take out cooked food from basket that has been placed; and remove a basket out of the system with or without food in it.

In embodiments, and with reference to FIG. 14, a camera may be arranged with the frame or wall 59 to obtain image data of the baskets, contents therein, and robot arm.

An example of a camera is a RGB camera. The image data can be used to detect basket's presence and to classify the food type therein. In embodiments, for every classification, the images are saved to be used for re-training the classifier so it gets better over time.

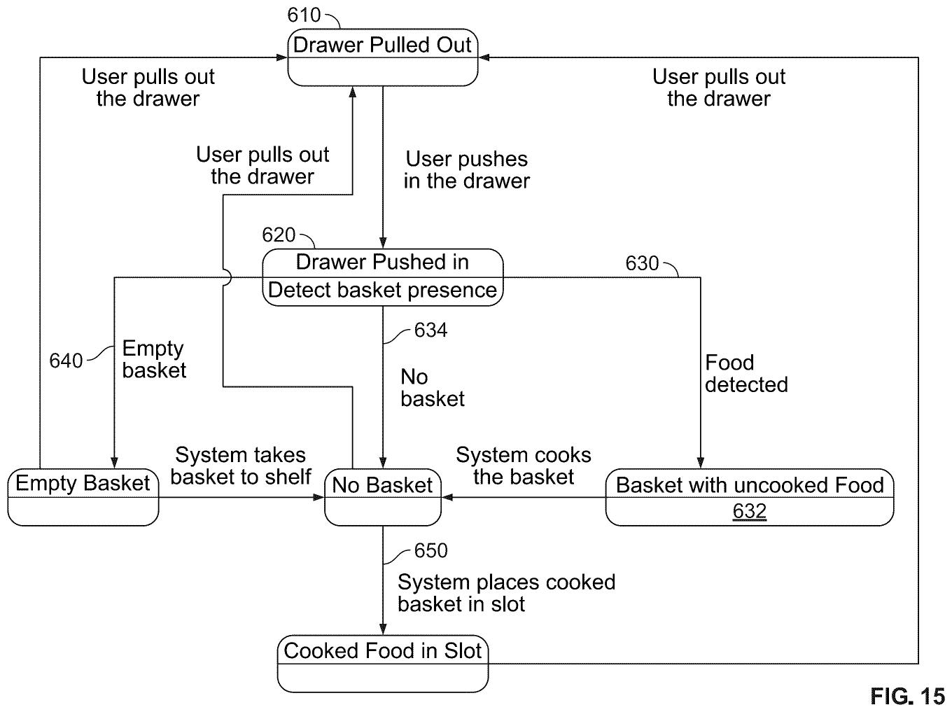

With reference to FIG. 15, another embodiment of the invention is shown. In this embodiment, an initial step is basket detection 620. In this step, the system is operable to detect whether a basket is present in a slot when the drawer is pushed into the slot as described herein.

If the system detects there is no basket in the slot 634, a basket can be placed there, either an empty basket 640 or a basket of cooked food (a “cooked basket” 650), which can be removed by the user pulling the drawer out 610.

If the system detects a basket is present in the slot, the system queries whether the basket contains food therein 630 or is empty 640.

If an empty basket is present 640, the user may pull out the drawer 610 to refill, clean, remove or replace the basket. Alternatively, the system may relocate the basket to a shelf as described herein, freeing up the slot.

If system detects food in the basket 630, the system classifies the type of the food so that the food can be cooked properly. If the food is cooked, the user may withdraw the drawer 610. In embodiments, as described herein, an indicator such as an LED effect notifies the food is cooked and ready to be removed.

### Basket Classification

When the camera detects a basket, the system classifies the basket. A main purpose of the classification is to detect the occupancy of the basket, either empty 640 or has some food type 630 that needs to be identified. In embodiments, the system can support specialty food item baskets, such as basket with taco insert or basket with lid. For a basket with a lid, the system cannot see the contents of the basket so the system is operable to query the user to manually classify the basket.

In embodiments the classification is done through a deep learning model such as a neural network model via e.g., supervised learning or reinforcement learning. The model is trained from the past data collected either in a laboratory environment or through actual restaurant-placed units. Using a reinforcement learning model, with data arising from actual use, the system will get better the more the data is collected because the system will keep learning to identify the food in the basket.

### Occlusion Rules

In embodiments of invention, the system has occlusion rules to make decisions even if the basket is occluded from view of the camera. The basket can be obstructed if the user and the robot arm interact with the automated basket at the same time. For example, the robot arm might block the camera during a critical moment. One instance is just after the user has placed a new order that needs to be recognized.

In embodiments, the system stores each of the arm configurations that block the camera. The vision system then pauses detection and classification until the camera view is not occluded.

Another potential occlusion circumstance is when the robot arm is placing a basket in the automated basket slot. During this time, the user might want to use that same slot to place a new basket. When this happens, the cameras will capture the newly placed basket and the robot arm will place the extra basket in a different slot. If the camera is occluded by the arm (such as the arm is already too close to the automated basket area), the arm will go back to the closest point where the camera is not occluded, assess the situation, and react accordingly. If there is no other automated basket slot to put the basket that the arm is already holding, the system will bring the extra basket back to one of the fryer shelves and bring it to the automated basket slot later when a spot is free.

### Sorting Food and Hot Hold

One advantage of using the automated basket as the return strategy for cooked food is that it is already pre-sorted. Since the uncooked food placed in a single basket 632 is typically of the same type, the cooked food that got returned automatically got sorted from the other cooked baskets. This is in contrast to the hot hold return strategy, where all the food items placed in the hot hold needs to be sorted manually.

### Automated Basket User Interface

As described above, it is to be appreciated that the automated basket system 50 is used by both the robotic arm and the user. Inventors have found that there is an advantage for the robotic arm to communicate with the user whether the robot arm is about to use a particular automated basket slot or to inform the user of the status of a particular slot. In embodiments, and with reference to FIG. 12, LEDs 67 (optionally, a horizontal LED strip) are arranged on the wall above each of the drawers 54a, 54b. In embodiments, communication is performed by a LED lighting attached to each automated basket slot that changes color or patterns depending on the status of the robot arm. For embodiments, at least one of the following LEDs is implemented:
Effect 1 (e.g., White): Automated basket slot is empty and ready to use.
Effect 2 (e.g., Orange): Food is cooked and ready to be picked up.
Effect 3 (e.g., Blinking orange): The robot arm is about to place a cooked food in that particular slot. This is important for the user to know in order to avoid putting another basket in that same slot. Doing this will make the robot arm needing to re-assess the area and finding another slot to place that basket, resulting in a slower throughput.
Effect 4 (e.g., Green): The robot arm confirms to the user that it sees the food and will cook it soon.

In alternative embodiments, other effects can be implemented to communicate with the operator. For example, the system can provide sound or display text.

With reference again to FIG. 6, step 140 states to manipulate first or second basket into fryer, corresponding to either the basket filled via the elevator station 30 or the basket filled via the auto-drawer station 50, respectively.

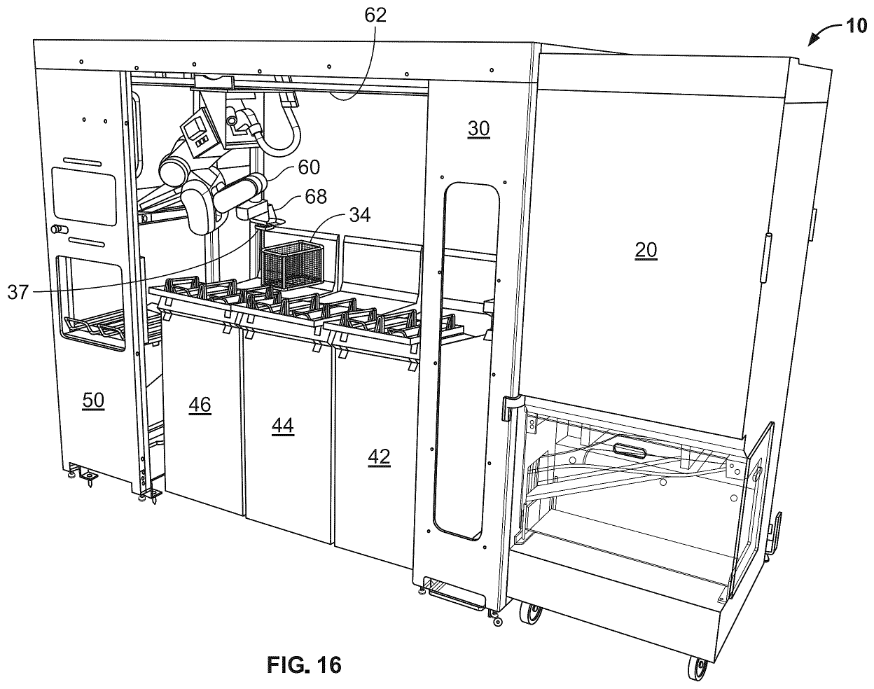

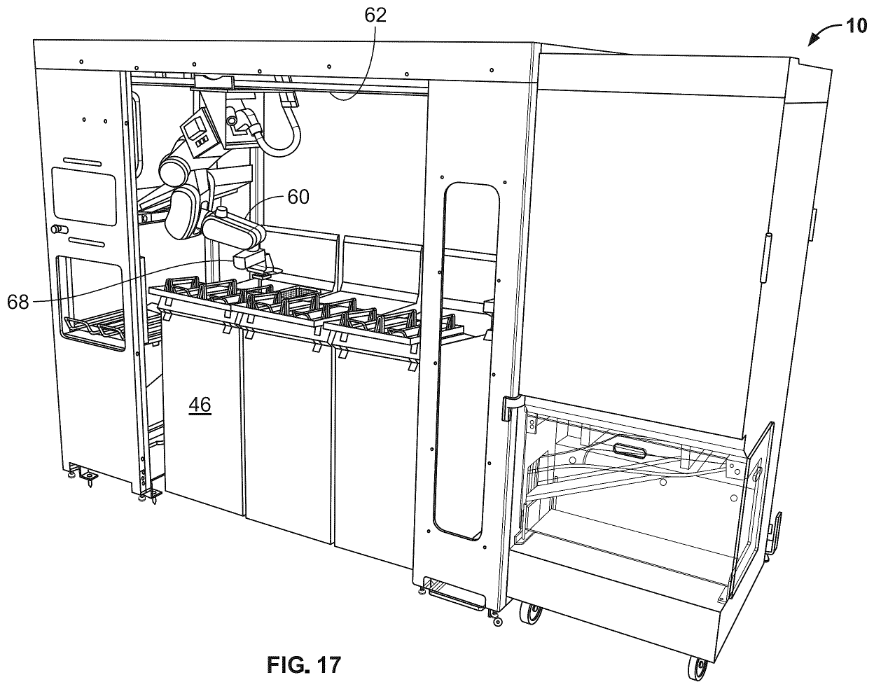

In embodiments, and with reference to FIGS. 16-17, a robotic arm 60 is shown moving the basket 34 into the oil reservoir of fryer 46. An exemplary robotic arm 60 has 6-axis motion (or degrees of freedom) such as the Yaskawa GP4 Arm manufactured by Yaskawa America, Inc., Motoman Robotics Division (Miamisburg, OH).

The robotic arm is shown mounted on a linear rail 62 from above the fryers. The linear rail uses no floorspace and enables the robotic arm 60 to move from one side of the enclosure (e.g., the elevator station 20) to the other side of the enclosure (e.g., the auto-drawer station 50) as well as make any stops therebetween. An exemplary linear rail/motor is the Y-Axis Rail, Yaskawa 450W servo SGMRV-05ANA-YR11 manufactured by Yaskawa America, Inc., Motoman Robotics Division (Miamisburg, OH).

Various sensors may be arranged on the frame and rail. An example of a type of sensor for calibrating the position of the robotic arm is a rail homing sensor such as the Contrinex Proximity Sensor DW-AD-613-C12P-1523 manufactured by Contrinex (Coppell, TX). Cables can be organized using IGUS E-chain 64.

The robotic arm assembly is shown including a gripper 68 for gripping a handle 37 of the basket 34. In embodiments, the gripper is a clamp-type assembly. An exemplary gripper is Zimmer Group GEP2016IO-05-B Gripper manufactured by Zimmer Group US Inc. (Hickory, NC). Examples of end effector clamping assemblies, holds and fry baskets are described in: U.S. Pat. No. 11,167,421, filed Aug. 7, 2019, entitled “ROBOTIC KITCHEN ASSISTANT INCLUDING UNIVERSAL UTENSIL GRIPPING ASSEMBLY”; U.S. Pat. No. 11,192,258, filed Aug. 7, 2019, entitled “ROBOTIC KITCHEN ASSISTANT FOR FRYING INCLUDING AGITATOR ASSEMBLY FOR SHAKING UTENSIL”, and US Publication No. 20230292957, filed Jan. 31, 2023, entitled “AUTOMATED FOOD FRYING SYSTEM”, each of which is incorporated herein by reference in its entirety.

Step 150 of the method states frying and agitating. The robotic arm 60 can be programmed to lower, shake, and raise the fry basket based on time, or optionally, camera or sensor feedback. Exemplary feedback information includes, without limitation, predicted food temperature or vision or IR-based recognition for food separation, doneness or cooking evenness. An example of a robotic kitchen arm for manipulating the fry basket is shown and described in U.S. Pat. No. 11,192,258, filed Aug. 7, 2019, and entitled “ROBOTIC KITCHEN ASSISTANT FOR FRYING INCLUDING AGITATOR ASSEMBLY FOR SHAKING UTENSIL”, incorporated herein by reference in its entirety for all purposes.

Step 160 states to manipulate first or second basket onto shelf for draining. This step may be performed by the robotic arm 60 lifting the fry basket 34 out of the fryer 46, and allowing the contents to gravity drain above the fryer. Optionally, the robotic arm can be programmed to shake the contents. Optionally, computer vision can be used to observe for doneness, separation, or quality of the food items.

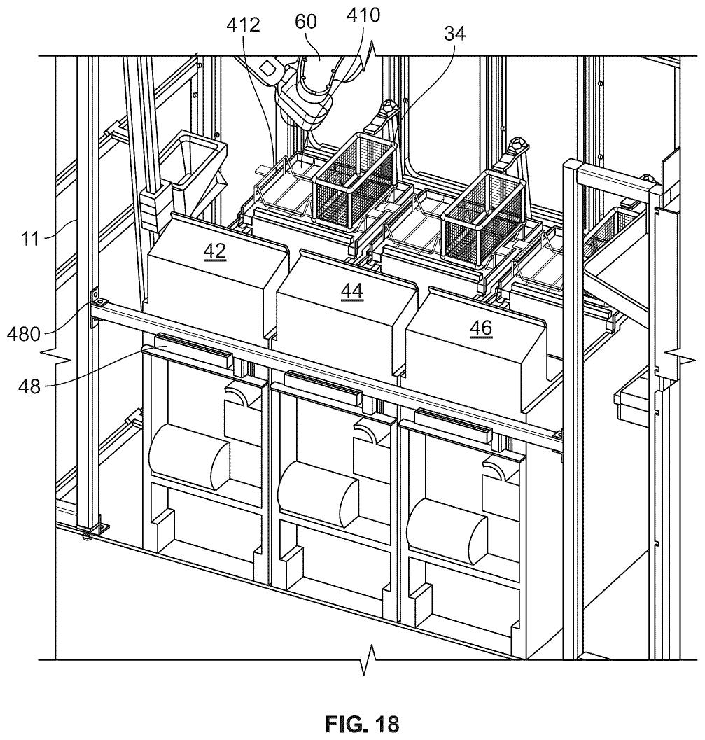

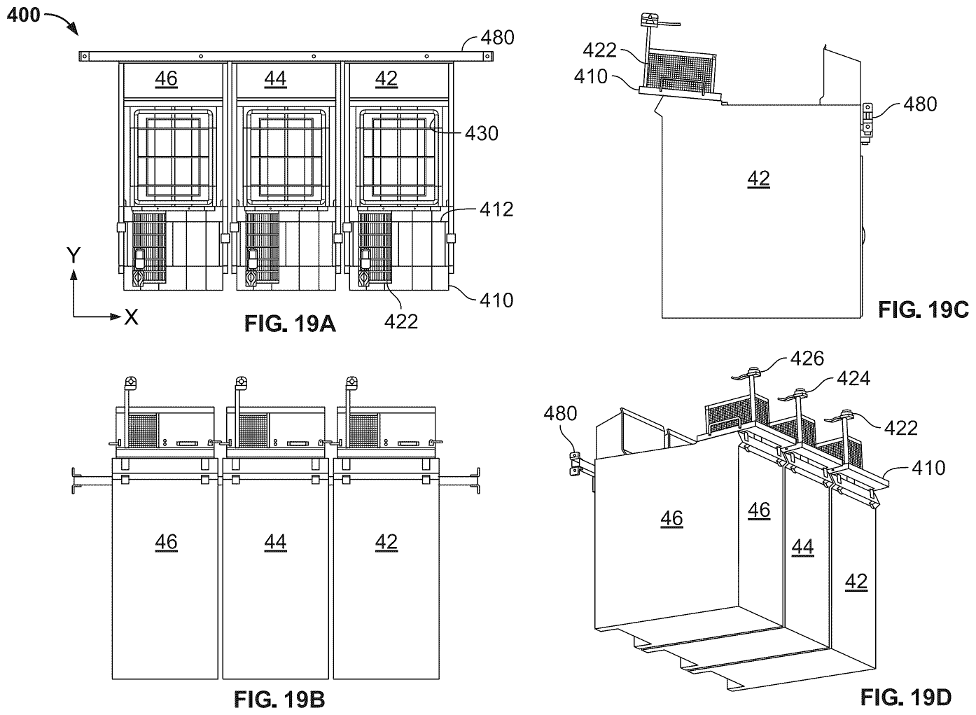

With reference to FIGS. 18-19, a fryer and basket location implementation includes arranging each of the fryers 42, 44, 46 in a fixed position within the enclosure or frame 11. In embodiments, electronic magnetic fryer locks 48 couple each of the fryers to a horizontal bar 480 attached to frame 11. In embodiments, proximity sensors are incorporated into the bar and/or frame for monitoring or confirming position of the fryers. The computer system and electronics can be operable to alert the user or halt operations if a fryer is outside of an acceptable distance from its target location.

FIGS. 19A-19D show different isolated views of a fryer and location basket implementation 400. Each of the fryers includes a fryer localization fixture 412 in the form of a cage or frame. The open frame 412 supports the fry basket 422 in the XY plane and outside of the oil footprint of the oil reservoir 430. As shown, each fry basket localization fixture includes two defined regions (or slots) to accommodate two fry baskets. The implementation shown in FIGS. 19A-19D can accommodate draining or holding up to 6 fry baskets while frying or waiting. Such a configuration offers flexibility during scheduling and increases throughput as multiple fryer baskets can be draining and cooking simultaneously. In contrast, holding one fry basket over the oil limits access to the oil reservoir, reducing throughput.

The implementation shown in FIGS. 19A-19D also shows shelves 410 under each of the frames. The shelves 410 are arranged at a slight angle or tilt towards the oil in the fryers. Oil drippings that fall onto the shelves are directed back to the oil reservoir in the fryer. Optionally, the frame and shelf may be one integrated unit or separate components detachably arranged together.

In embodiments, the robotic arm and computer system are programmed and operable to place the shelves and frames during cooking operations or as otherwise desired. For example, if a fryer needs a new shelf or frame, the robotic arm can move it to the auto-drawer assembly to be transferred from the robotic enclosure. A new shelf and frame may be delivered into the robotic enclosure via the auto-drawer assembly. In embodiments, swapping or interchanging shelves 410 and frames 412 can thus be performed automatically and without violating the robotic enclosure.

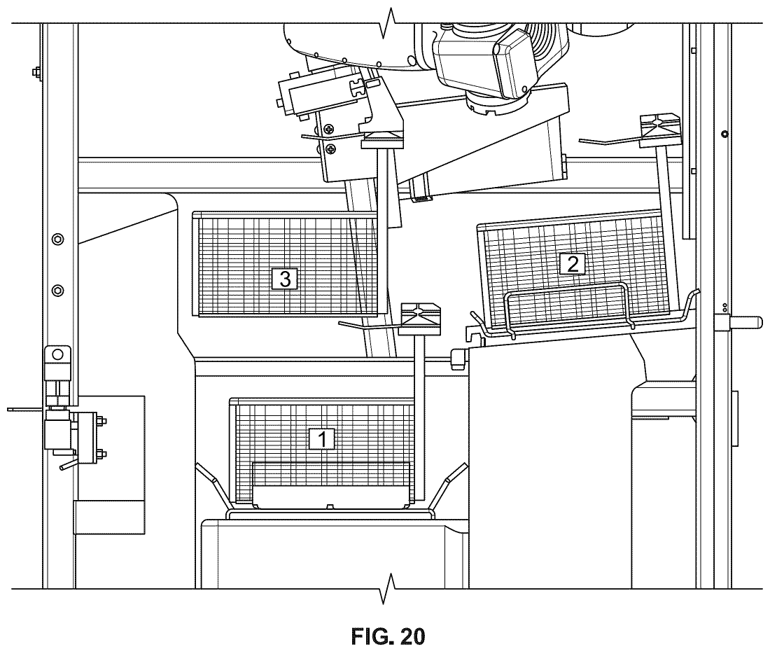

With reference to FIG. 20, arranging a basket (2) on the shelf allows for more space than when the robot is traversing with baskets above the fryer vats (3). Having the stored position on the fryer shelf (2) instead of in the vat (1) or above the oil (3) allows one to have more (or a full) system of baskets. Otherwise, there would be one less basket than places to locate them.

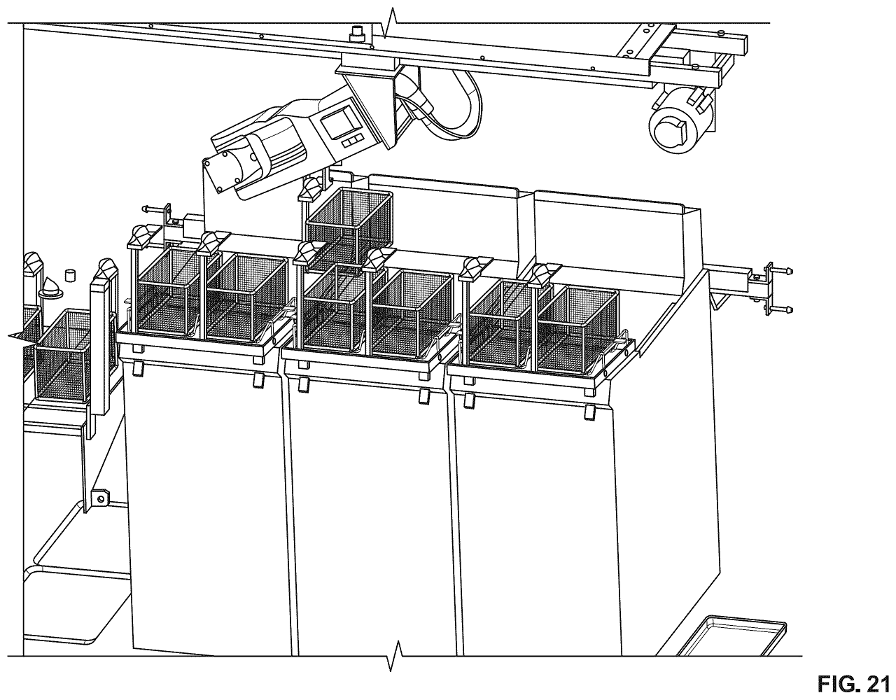

With reference to FIG. 21, in embodiments, a system can operate simultaneously with 8 baskets including 6 fryer slots and two auto-drawer/basket slots.

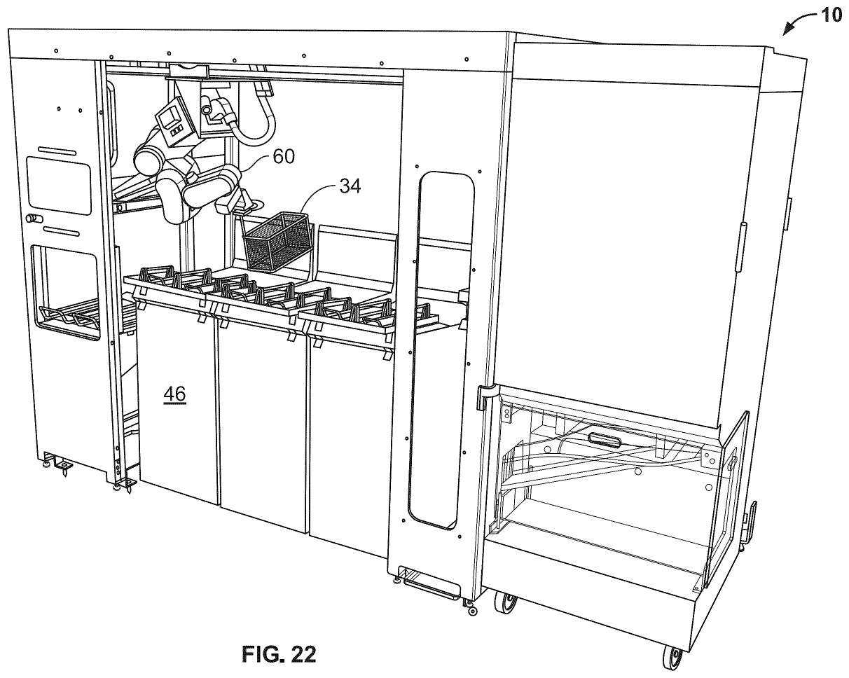

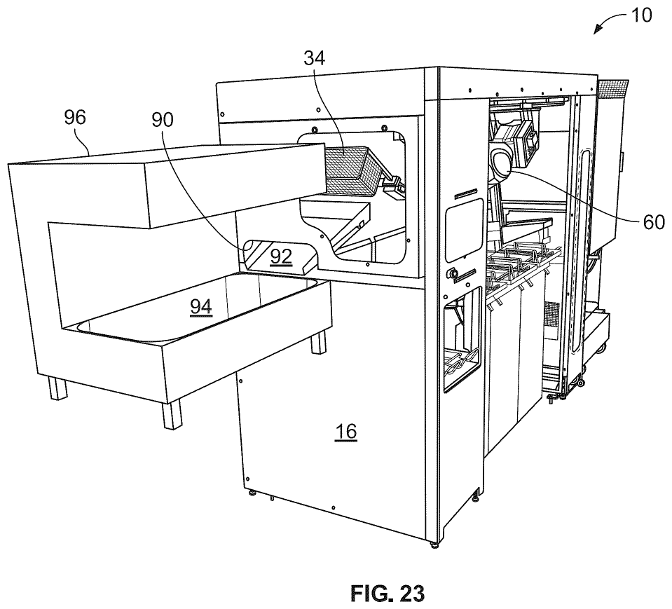

Step 170 states to transfer or dump the cooked food items to exit chute. This step may be performed by the robotic arm 60 manipulating the fry basket 34 as shown in FIGS. 22-23 to raise and rotate the fry basket, respectively, thereby dumping any contents in the fry basket onto chute 92. The cooked food is gravity fed and aimed out the egress window 90 into cooked food holding station 96, and receiving tray 94 (collectively sometimes referred to as a ‘hot hold’). Station 96 may include heat elements (e.g., a heat lamp) to keep the cooked food warm while in the tray 94.

Accordingly, the method 100 automatically and robotically cooks the food from start to finish including safely accepting custom or unplanned orders into the robotic workspace through an auto-drawer station.

### Hardware Block Diagram

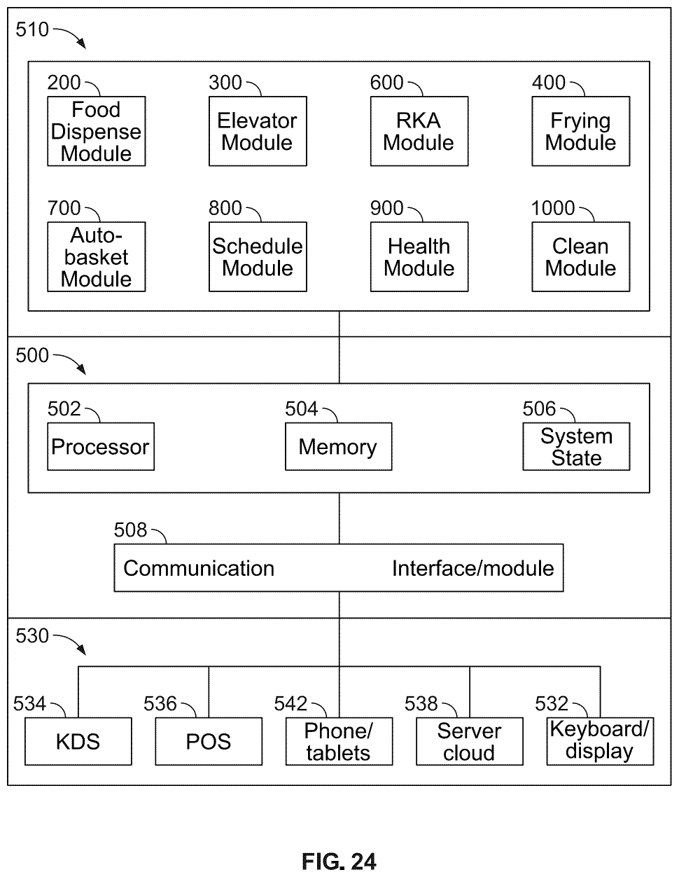

With reference to FIG. 24, a block diagram of a food fryer system includes a plurality of functional modules 510, a computer and electronics 500, and one or more input services or devices 530.

Examples of functional modules 310 include: raw food dispense module 200, elevator module 300, fryer module 400, robotic arm module 600, automated basket module 700, Schedule module 800, health module 900, and clean module 1000. Each module is shown in communication with the computing system 500. In embodiments, the computing system 500 is operable to keep track of the state, and to provide instructions to each of modules. In embodiments of the invention, each module includes its own hardware and electronics including, e.g., a dedicated controller, motor or actuator, heat exchanger, processor, memory, PCB, integrated chip, and one or more sensors. Optionally, one or more of the modules are self-contained functional units that are conveniently coupled to the computing system 500. For example, in embodiments of the invention, the refrigerated hopper/dispenser 20 and fryer station 40 are self-contained units that are conveniently arranged with the frame 11, and connected electronically to the computer 500 to control the method steps as described above.

The computing device 500 can be a conventional micro-computer and the like including, for example, one or more processors 502, memory or storage devices 504, system state module 506 for keeping track of all events, status, and steps occurring during operation, and communication interface 508. However, the computing device may vary widely and include additional processors, types of memory, ports, communication interfaces (e.g., Wi-Fi, Bluetooth, ethernet, etc.), power supplies, and other components. The computing device 500 can be internal to or remote from the fryer system.

The computing device 500 can be responsive to instructions or requests from a number of input devices 530. Examples of input devices include, without limitation, POS systems 536, tablets and smart phone 542, kitchen display systems (KDS) 534, and onboard touch screens 70 or displays 532. Instructions or requests can be entered by an operator, team member, customer, or another as the case may be.

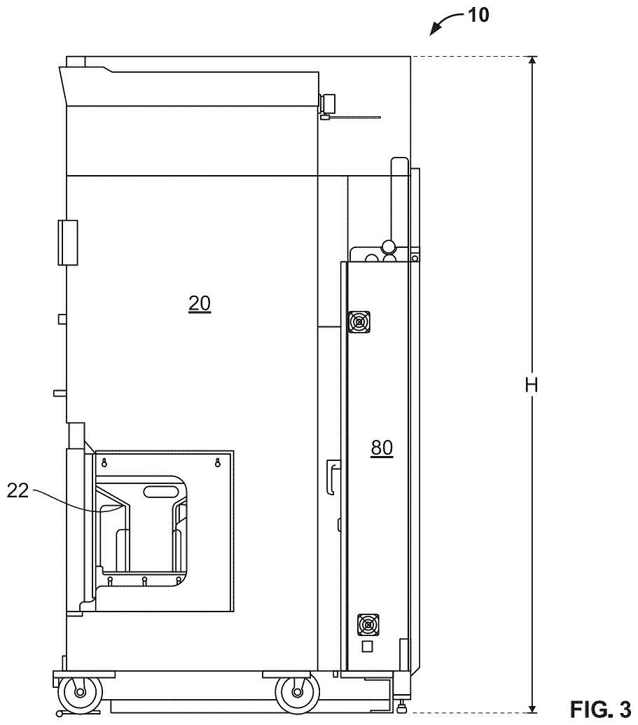

In embodiments, with reference to FIGS. 3, 5, the computing and electronics can be arranged in an enclosure 80 towards the rear of the system 10, behind the dispenser station 20, 200 and outside of the framed robotic workspace. In embodiments, the computer and electronics is conveniently accessed by rolling the dispenser unit 20 out of the way.

FIG. 24 also shows server 538 which can be remote or cloud-based. Such remote servers 538 can be used to generally communicate with the system, receive and store data, upload program updates, and host an associated a website. Local input devices (e.g., without limitation, tablets, smart phones, desktop or workstations) may download a program or App to conveniently communicate with the website to place an order and monitor activity.

Additionally, a wide variety of sensors can be incorporated with or otherwise used with each of the modules.

For example, a limit switch can sense when the elevator basin is at a first position. The system can be programmed to prohibit the hopper from dispensing food when the limit switch is not in the first position. An example of a suitable limit switch is model XVM3SBQF1802L03, manufactured by CIT Relay and Switch (Rogers, MN).

Photo-presence sensors can be used to monitor for whether an object is present. For example, should the fry basket not be detected, the method proceeds to stop operation until it is replaced. An example of a suitable photo-presence sensor is model WL15-A2430, manufactured by SICK AG, (Waldkirch, Germany).

Load sensors can be used to detect weight. Based on the detected weight, the system can compute whether the proper amount of food has been dispensed into the elevator basin. An example of a suitable load cell is model LCEB, manufactured by Omega Engineering Inc. (Norwalk, CT).

Break beam sensors/reflectors can monitor for a break in the beam. For example, the break beam sensor can monitor if the elevator or automated baskets are in the first position. An example of a suitable break beam sensor and reflector is model O6S202-O6S-OOKG/AS/3P, manufactured by ifm Efector, Inc. (Malvern, PA 19355).

In embodiments, a safety light curtain for monitoring the ingress window of the auto-drawer is based on use of break beam sensors.

Proximity sensor(s) can monitor for position of the components. For example, one or more proximity sensors may be used to detect the position of the elevator. An example of a suitable proximity sensor is model DW-AD-504-M5, manufactured by Contrinex Gmbh. (Corminboeuf, Switzerland).

In embodiments of the invention, cameras are added and aimed at one or more of the stations. The camera images are sent to the computer processors for determining food item recognition, localization, tracking, food aggregation/clumping, and food doneness. Computer modules for use with the cameras and sensors are described in US Patent Publication No. 20210022559, filed Jul. 25, 2020, entitled “TRANSPORTABLE ROBOTIC-AUTOMATED KITCHEN WORKCELL”, U.S. Pat. No. 10,919,144, filed Aug. 10, 2018, entitled “MULTI-SENSOR ARRAY INCLUDING AN IR CAMERA AS PART OF AN AUTOMATED KITCHEN ASSISTANT SYSTEM FOR RECOGNIZING AND PREPARING FOOD AND RELATED METHODS”, and US Patent Publication No. 20220386807, filed Jun. 1, 2022, entitled “AUTOMATED KITCHEN SYSTEM FOR ASSISTING HUMAN WORKER PREPARE FOOD”, each of which is incorporated herein by reference in its entirety.

### Fry Basket

In embodiments, and with reference again to FIG. 11, a fry basket assembly 34A can include a frame 31 and a traditional rectangular-shaped lower basket portion formed of a screen or mesh. A handle 37 is shown extending out of the basket portion from the right side rear corner. A diamond shaped hold 35 is arranged towards the top of the shaft for the gripper of the robotic arm (not shown) to clamp. The fry basket assembly also includes a marker plate 39 for the camera system to locate and track the fry basket assembly.

Additionally, if use of a conventional fry basket is desired that has a pre-integrated long handle, an adapter can be mounted to the handle of the fry basket for the clamping assembly of the robotic arm to grip.

Examples of end effector clamping assemblies, holds and fry baskets are described in: U.S. Pat. No. 11,167,421, filed Aug. 7, 2019, entitled “ROBOTIC KITCHEN ASSISTANT INCLUDING UNIVERSAL UTENSIL GRIPPING ASSEMBLY”; U.S. Pat. No. 11,192,258, filed Aug. 7, 2019, entitled “ROBOTIC KITCHEN ASSISTANT FOR FRYING INCLUDING AGITATOR ASSEMBLY FOR SHAKING UTENSIL”, and US Publication No. 20230292957, filed Jan. 31, 2023, entitled “AUTOMATED FOOD FRYING SYSTEM”, each of which is incorporated herein by reference in its entirety.

Indeed, there are many arrangements to couple a fry basket, handle and robotic arm to one another, all of which are intended to be included in the present invention except where specifically excluded in any appended claims.

### Alternative Embodiments

The invention is intended to include a wide variety of embodiments.

In embodiments, the drawers of the auto-drawer station are automatically operated to extend or retract. A motor or actuator can be arranged with the drawer rails to move the drawer in and out of the robot enclosure based on instructions from the operator or other sensed data. In embodiments, the user may actuate the drawer via the touchscreen display 70.

For example, it is to be understood the functional modules may be arranged differently than that shown; some functional units may be removed; and additional functional units (whether serving the same or different purpose) may be added to the system to increase throughput or types of food offerings as desired.

1. An automated food frying system comprising:
an enclosure defining a robot workspace from a human workspace;
a robotic arm arranged within the robot workspace;
a plurality of functional stations comprising:
a dispensing station for dispensing raw food into a designated location within the enclosure;
a food transfer station arranged within the enclosure to receive the raw food from the dispensing station, and operable transfer the raw food to a fry basket;
a fry station arranged within the enclosure and comprising at least one fryer for frying the fry basket of raw food into cooked food; and
an auto-drawer station arranged within the enclosure comprising at least one drawer movable from a retracted first configuration within the enclosure to an extended second configuration through an ingress window outside of the enclosure, and wherein the at least one drawer and ingress window are arranged, sized and operable to transfer a fry basket between a human outside of the enclosure and the robotic arm inside of the enclosure without the human or robotic arm penetrating a boundary defined by the enclosure;
a computer system programmed to control the plurality of functional stations and robotic arm to dispense the raw food to either a basin or a fry basket, transfer the raw food to the fry basket if not already in the fry basket, fry the raw food, transfer the cooked food to an egress area for transferring the cooked food from inside the enclosure to outside the enclosure.

2. The system of claim 1, wherein the food transfer station comprises:
a basin comprising an openable door through which the raw food can fall through based on gravitational forces; and
an elevator comprising a linear actuator and a carriage assembly operable to move the basin up and down along the linear actuator between a first elevation for receiving the raw food from the dispensing station and a second elevation higher than the first elevation for dumping the raw food into a fry basket.

3. The system of claim 2, wherein the elevator assembly comprises:
at least one sensor for detecting when the basin is at second location for dispensing the raw food into the fry basket; and
at least one sensor for detecting when the door is open.

4. The system of claim 2, wherein the dispensing station includes a cold storage, a hopper, and a ramp to direct the raw food into the elevator basin when the basin is positioned at the first elevation.

5. The system of claim 1, further comprising a clamp assembly mounted to the robotic arm via an end effector, wherein the clamp assembly is adapted to detachably hold the fry basket or to hold an adapted, optionally a diamond-shaped, on the fry basket.

6. The system of claim 1, wherein the computer is programmed and operable store and update status of the food, wherein the status comprises at least one status from the groups comprising: on-line/ready, dispensing, frying, order ready/pickup, service, off-line.

7. The system of claim 6, wherein the computer is programmed and operable to receive orders, make modifications to the order, and provide reports including the order, status, and time.

8. The system of claim 1, wherein the auto-drawer station comprises at least one sensor to detect when the drawer is closed.

9. The system of claim 8, further comprising a safety light curtain configured to sense when the ingress window has been penetrated by an object.

10. The system of claim 9, wherein the auto-drawer station comprises a plurality of drawers, and optionally, each drawer is manually operated.

11. The system of claim 1 wherein the fry station comprises at least one fryer, and an in-fryer localizer shelf arranged with each of said at least one fryer to support the basket in the z-plane and to fix the basket in the X-Y plane, and optionally.

12. The system of claim 11, wherein the fry station comprises at least two shelves per fryer for staging and queuing empty baskets when not used.

13. The system of claim 1, wherein each fryer has a localization sensor to detect position of the fryer relative to the enclosure, and optionally, wherein each fryer is locked in place relative to the enclosure via an electromagnetic lock.

14. A method for automatically frying food comprising the following steps:
automatically selecting, based on a customer order and data arising from sensors or cameras, between whether to:
dispense a raw food into a basin, and to transfer the raw food from the basin to a fry basket;
pick up a fry basket of raw food from an auto-drawer station;
robotically manipulating the fry basket of raw food to a fry station;
frying the raw food into cooked food; and
robotically transferring the cooked food from a protected enclosure to an unprotected food holding station for pickup without a human or the robotic arm penetrating a boundary defined by the enclosure; and
wherein each of the steps is controlled by a computer system.

15. The method of claim 14, wherein the transferring the raw food comprises elevating the raw food, robotically arranging a fry basket under the basin, and automatically opening a door for the raw food to be dumped from the basin into the fry basket.

16. The method of claim 14, further comprising sliding a fry basket of raw food through an ingress window into the enclosure without a human or the robotic arm penetrating a boundary defined by the enclosure.

17. The method of claim 14, comprising removing a fry basket from the enclosure through the ingress window without a human or the robotic arm penetrating a boundary defined by the enclosure, and stopping the robotic arm if the ingress window of the enclosure is penetrated by an object.

18. The method of claim 14, further comprising shelving at least one fry basket on a fryer at a location outside of a footprint of the oil reservoir of the fryer such that access to the oil reservoir is not blocked while the fry basket is shelved.

19. The method of claim 14, further comprising, based on real-time image data generated by at least one camera, classifying whether a basket is present in the auto-drawer, and the type of food in the basket if the basket is present.

20. The method of claim 19, further comprising employing a set of occlusion rules if the robotic arm is occluded from view of the camera.
